(19) United States
(12) Patent Application Publication
(10) Pub. No.: US 2026/0177874 A1
(43) Pub. Date: Jun. 25, 2026

(54) OPTICAL DEVICES AND METHODS OF MANUFACTURE

(71) Applicant: Taiwan Semiconductor Manufacturing Co., Ltd., Hsinchu (TW)

(72) Inventors: Chia-Han Tsou, Hsinchu (TW); Ming-Fa Chen, Taichung (TW)

(21) Appl. No.: 19/189,572

(22) Filed: Apr. 25, 2025

Related U.S. Application Data
(60) Provisional application No. 63/737,954, filed on Dec. 23, 2024.

(51) Int. Cl. G02F 1/21; G02F 1/035

(52) U.S. Cl. CPC G02F 1/212; G02F 1/035; G02F 2201/302; G02F 2201/34; G02F 2202/20

(57) ABSTRACT

A method of forming an optical device as well as the optical device itself are described herein in which a modulator device is bonded to a photonic integrated circuit. The photonic integrated circuit has a modulator that can be used to modulate optical signals from the photonic integrated circuit and the modulator is formed using lithium niobate.

### PRIORITY CLAIM AND CROSS-REFERENCE

This application claims the benefit of U.S. Provisional Application No. 63/737,954, filed on Dec. 23, 2024, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

An optical device can provide for the coupling of optical signals from an optical fiber to an optical waveguide for use in optical signaling and processing systems. The efficiency of optical coupling and optical modulating has gradually improved, making the design of the individual couplers and modulators relevant to advancing optical signal transmission. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a substrate used in a method for forming a photonics platform, in accordance with some embodiments.

FIG. 2 illustrates formation of dielectric layers over the substrate, in accordance with some embodiments.

FIG. 3 illustrates formation of optical components, in accordance with some embodiments.

FIG. 4 illustrates attachment of a first semiconductor device, in accordance with some embodiments.

FIG. 5 illustrates removal of the substrate, in accordance with some embodiments.

FIGS. 6A-6C illustrate a modulator device, in accordance with some embodiments.

FIG. 7 illustrates a bonding of the modulator device, in accordance with some embodiments.

FIG. 8 illustrates formation of metallization layers, in accordance with some embodiments.

FIG. 9 illustrates a first simplified optical path, in accordance with some embodiments.

FIG. 10 illustrates a second simplified optical path, in accordance with some embodiments.

FIG. 11 illustrates a third simplified optical path, in accordance with some embodiments.

FIGS. 12A-12C illustrates formation of a reflector, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be illustrated and discussed in which a modulator device is utilized to provide modulation to a first optical package without the first optical package being poisoned from the materials within the modulator die. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

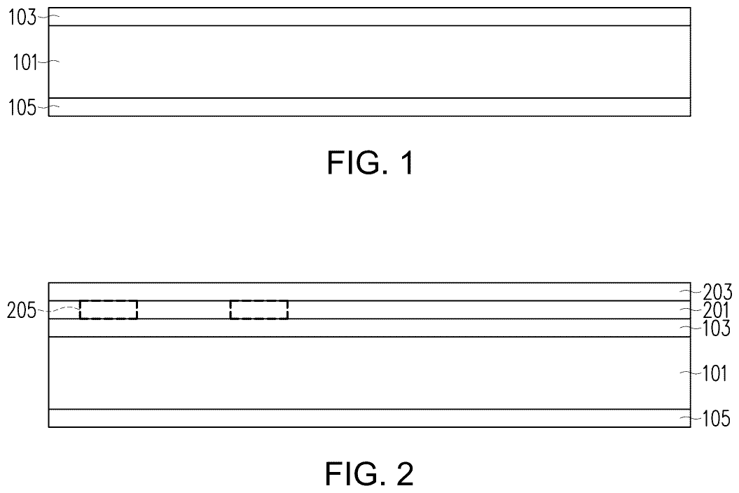

With reference now to FIG. 1, there is illustrated an initial structure that includes a first substrate 101 located between a first isolation layer 103 and a second isolation layer 105. Looking first at the first substrate 101, the first substrate 101 may be a semiconductor material such as silicon or germanium, a dielectric material such as glass, or any other suitable material that allows for structural support of overlying devices.

In an embodiment the first isolation layer 103 and the second isolation layer 105 may be silicon oxide, silicon nitride, germanium oxide, germanium nitride, combinations of these, or the like, formed using a method such as implantation (e.g., to form buried oxide (BOX) layers) or else may be deposited on opposite sides of the first substrate 101 using a deposition method such as chemical vapor deposition, atomic layer deposition, physical vapor deposition, combinations of these, or the like. However, any suitable material and method of manufacture may be used.

FIG. 2 illustrates a deposition of a first dielectric layer 201 and a second dielectric layer 203 over the first isolation layer 103. In an embodiment the first dielectric layer 201 may be a dielectric material such as silicon nitride or the like, using a deposition method such as chemical vapor deposition, atomic layer deposition, physical vapor deposition, or the like. The first dielectric layer 201 may be deposited to a thickness of between about 3,000 Å and about 5,000 Å, such as about 4,000 Å. However, any suitable material, process and thickness may be utilized.

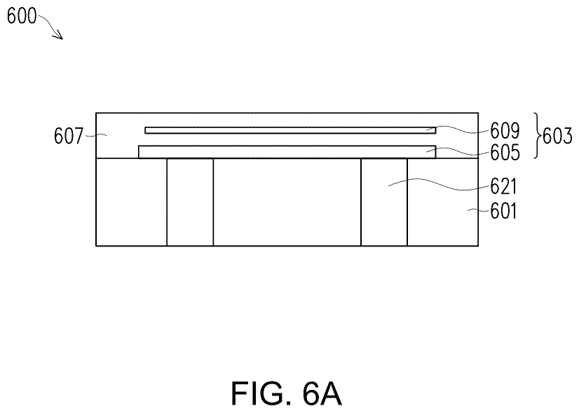

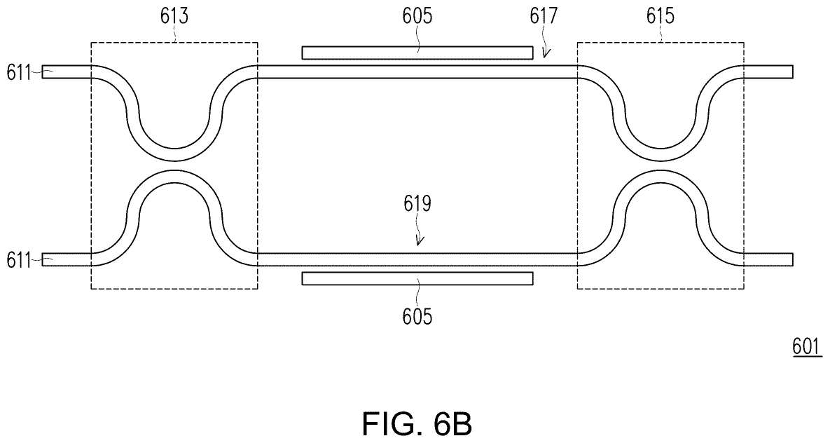

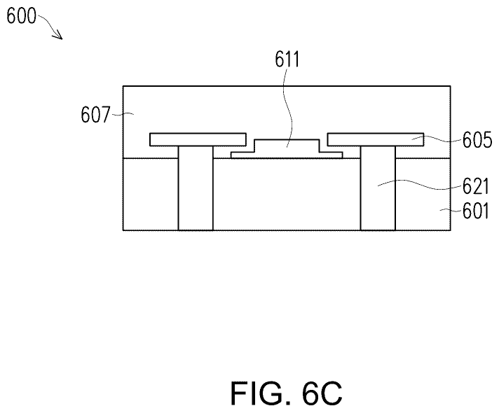

If desired, and in embodiments in which the first dielectric layer 201 is formed from a material that can be used as core material (e.g., silicon nitride), the first dielectric layer 201 may further be patterned to form backside optical devices (represented in FIG. 2 by the dashed boxes labeled 205) from the material of the first dielectric layer 201 (e.g., silicon nitride). In some embodiments the backside optical components 205 may include such components as optical waveguides (e.g., ridge waveguides, rib waveguides, buried channel waveguides, diffused waveguides, etc.), couplers (e.g., edge couplers, grating couplers, etc.) for connection to outside signals, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more backside optical components 205. In a particular embodiment, at least a portion of the backside optical components 205 may be waveguides that will underlie a subsequently connected modulation device 600 (not illustrated in FIG. 2 but illustrated and discussed further below with respect to FIGS. 6A-6C) in order to provide optical signal inputs and outputs to the modulation device 600.

In an embodiment the material of the first dielectric layer 201 may be patterned into the desired shapes for the one or more backside optical components 205. In an embodiment the material of the one or more backside optical components 205 may be patterned using, e.g., one or more photolithographic masking and etching processes. However, any suitable method of patterning the material for the one or more backside optical components 205 may be utilized.

The second dielectric layer 203 may be another dielectric material such as silicon oxide or the like, using a deposition method such as chemical vapor deposition, atomic layer deposition, physical vapor deposition, or the like. The second dielectric layer 203 may be deposited over and around the first dielectric layer 201 and any of the backside optical components 205 to a thickness of between about 2,000 Å and about 3,000 Å. However, any suitable material, process and thickness may be utilized.

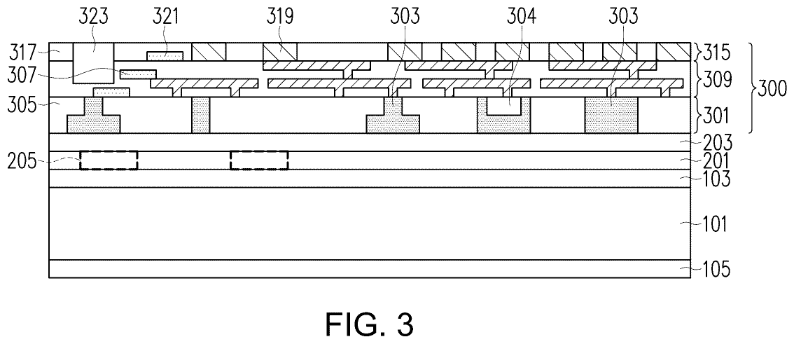

FIG. 3 illustrates formation of a photonic integrated circuit (PIC) 300 over the second dielectric layer 203. In an embodiment the formation of the PIC 300 may be initiated by initially forming a material (not separately illustrated) for a first active layer 301 of first optical components 303. In an embodiment, the material for the first active layer 301 may be a translucent material that can be used as a core material for the desired first optical components 303, such as a semiconductor material such as silicon, germanium, silicon germanium, combinations of these, or the like, while in other embodiments the material for the first active layer 301 may be a dielectric material such as silicon nitride or the like, although in other embodiments the material for the first active layer 301 may be III-V materials or polymers. In embodiments in which the material of the first active layer 301 is deposited, the material for the first active layer 301 may be deposited using a method such as epitaxial growth, chemical vapor deposition, atomic layer deposition, physical vapor deposition, combinations of these, or the like. However, any suitable materials and methods of manufacture may be utilized to form the material of the first active layer 301.

Once the material for the first active layer 301 is ready, the first optical components 303 for the first active layer 301 are manufactured using the material for the first active layer 301. In embodiments the first optical components 303 of the first active layer 301 may include such components as optical waveguides (e.g., ridge waveguides, rib waveguides, buried channel waveguides, diffused waveguides, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 303 may be used.

To begin forming the first active layer 301 of the first optical components 303 from the initial material, the material for the first active layer 301 may be patterned into the desired shapes for the first active layer 301 of first optical components 303. In an embodiment the material for the first active layer 301 may be patterned using, e.g., one or more photolithographic masking and etching processes. However, any suitable method of patterning the material for the first active layer 301 may be utilized. For some of the first optical components 303, the patterning process may be all or at least most of the manufacturing that is used to form these first optical components 303.

For those components that utilize further manufacturing processes, such as Mach-Zehnder silicon-photonic switches that utilize resistive heating elements, additional processing may be performed either before or after the patterning of the material for the first active layer 301 for forming the first optical components. For example, implantation processes, additional deposition and patterning processes for different materials (e.g., resistive heating elements, III-V materials for converters), combinations of all of these processes, or the like, can be utilized to help further the manufacturing of the various desired first optical components 303. In a particular embodiment, and as specifically illustrated in FIG. 3, in some embodiments an epitaxial deposition of a semiconductor material 304 such as germanium (used, e.g., for electricity/optics signal modulation and transversion) may be performed on a patterned portion of the material of the first active layer 301. In such an embodiment the semiconductor material 304 may be epitaxially grown in order to help manufacture, e.g., a photodiode for an optical-to-electrical converter. All such manufacturing processes and all suitable first optical components 303 may be manufactured, and all such combinations are fully intended to be included within the scope of the embodiments.

Once the first optical components 303 have been formed, a second insulator layer 305 may be deposited to cover the first optical components 303. The second insulator layer 305 may provide additional cladding material. In an embodiment the second insulator layer 305 may be a dielectric layer that separates the individual components of the first active layer 301 from each other and from the overlying structures and can additionally serve as another portion of cladding material that surrounds the first optical components 303. In an embodiment the second insulator layer 305 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 305 has been deposited, the material may be planarized using, e.g., a chemical mechanical polishing process in order to either planarize a top surface of the second insulator layer 305 (in embodiments in which the second insulator layer 305 is intended to fully cover the first optical components 303) or else planarize the second insulator layer 305 with top surfaces of the first optical components 303. However, any suitable material and method of manufacture may be used.

Once the first optical components 303 have been manufactured and the second insulator layer 305 has been formed, one or more second optical components 307 may be formed as part of first metallization layers 309. In some embodiments the second optical components 307 of the first metallization layers 309 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 307.

In an embodiment the one or more second optical components 307 may be formed by initially depositing a material for the one or more second optical components 307. In an embodiment the material for the one or more second optical components 307 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 307 has been deposited or otherwise formed, the material may be patterned into the desired shapes for the one or more second optical components 307. In an embodiment the material of the one or more second optical components 307 may be patterned using, e.g., one or more photolithographic masking and etching processes. However, any suitable method of patterning the material for the one or more second optical components 307 may be utilized.

For some of the one or more second optical components 307, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 307. For example, implantation processes, additional deposition and patterning processes for different materials, combinations of all of these processes, or the like, and can be utilized to help further the manufacturing of the various desired one or more second optical components 307. All such manufacturing processes and all suitable one or more second optical components 307 may be manufactured, and all such combinations are fully intended to be included within the scope of the embodiments.

Additionally, while the one or more second optical components 307 may be formed to create optical components in a single layer, this in intended to be illustrative and is not intended to limit the embodiments. Rather, the one or more second optical components 307 may comprise multiple layers of core material and cladding material. In still other embodiments, the one or more second optical components 307 may be formed to work in conjunction with portions of the first optical components 303 to form devices such as dual layer grating couplers or the like, where a first portion of the desired grating coupler is formed as one of the first optical components 303 and a second portion of the desired grating coupler is formed as one of the one or more second optical components 307. Any suitable combination of optical devices in the first optical components 303 and the second optical components 307, or even a single optical device that spans between the two, is fully intended to be included within the scope of the embodiments.

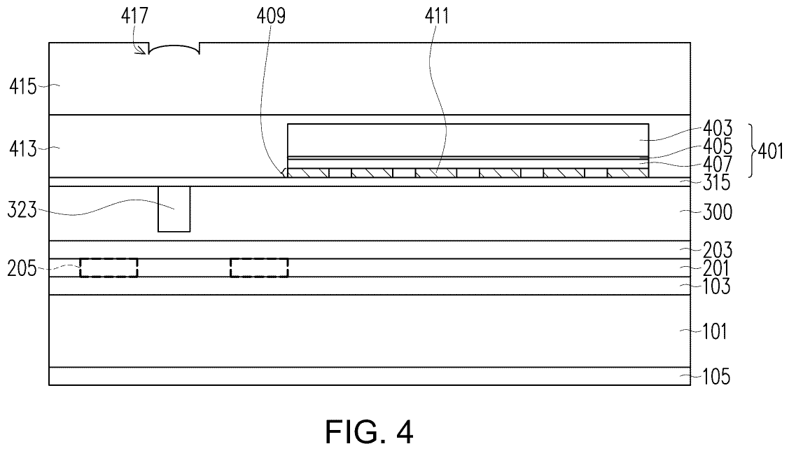

A remainder of the first metallization layers 309 is formed over and around the second optical components 307. In an embodiment the first metallization layers 309 are formed in order to electrically connect the first active layer 301 of first optical components 303 to control circuitry, to each other, and to subsequently attached devices (not illustrated in FIG. 3 but illustrated and described further below with respect to FIG. 4). In an embodiment the first metallization layers 309 are formed of alternating layers of dielectric (deposited to cover the one or more second optical components 307) and conductive material and may be formed through any suitable processes (such as deposition, damascene, dual damascene, etc.). In particular embodiments there may be multiple layers of metallization used to interconnect the various first optical components 303, but the precise number of first metallization layers 309 is dependent upon the design.

Once the first metallization layers 309 have been manufactured, a first bonding layer 315 is formed over the first metallization layers 309. In an embodiment, the first bonding layer 315 may be used for a dielectric-to-dielectric and metal-to-metal bond. In accordance with some embodiments, the first bonding layer 315 is formed of a first dielectric material 317 such as silicon oxide, silicon nitride, or the like. The first dielectric material 317 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 317 has been formed, first openings in the first dielectric material 317 are formed to expose conductive portions of the underlying layers in preparation to form first bond pads 319 within the first bonding layer 315. Once the first openings have been formed within the first dielectric material 317, the first openings may be filled with a seed layer and a plate metal to form the first bond pads 319 within the first dielectric material 317. The seed layer may be blanket deposited over top surfaces of the first dielectric material 317 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 317 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 319 within the first bonding layer 315. In some embodiments a bond pad via (not separately illustrated) may also be utilized to connect the first bond pads 319 with underlying conductive portions and, through the underlying conductive portions, connect the first bond pads 319 with the first metallization layers 309.

Additionally, the first bonding layer 315 may also include one or more third optical components 321 incorporated within the first bonding layer 315. In such an embodiment, prior to the deposition of the first dielectric material 317, the one or more third optical components 321 may be manufactured using similar methods and similar materials as the one or more second optical components 307 (described above), such as by being waveguides and other structures formed at least in part through a deposition and patterning process. However, any suitable structures, materials and any suitable methods of manufacture may be utilized.

Additionally, if desired, a pathway 323 for optical signals may be formed through the layers of the first metallization layer 309 and the first bonding layer 315. In an embodiment, at any desired point in the processes to form the multiple layers of the first metallization layer 309 and the first bonding layer 315, the materials directly over a coupler (e.g., a grating coupler) may be removed using, e.g., one or more masking and etching processes. Once these materials have been removed, the remaining opening is then filled with a dielectric material suitable for assisting in the transmission of the optical signals into and out of the grating coupler. However, in other embodiments the pathway may be left out.

FIG. 4 illustrates a bonding of a first semiconductor device 401 to the first bonding layer 315 (with the structures in FIG. 4 being shown in a simplified form for clarity). In some embodiments, the first semiconductor device 401 is an electronic integrated circuit (EIC—e.g., a device without optical devices) and may have a semiconductor substrate 403, a layer of active devices 405 with transistors (e.g., gates, source/drain regions, contacts), an overlying interconnect structure 407 (e.g., a back end of line structure), a second bonding layer 409, and associated second bond pads 411. In an embodiment the semiconductor substrate 403 may be similar to the first substrate 101 (e.g., a semiconductor material such as silicon or silicon germanium), the active devices 405 may be transistors, capacitors, resistors, and the like formed over the semiconductor substrate 403, the interconnect structure 407 may be similar to the first metallization layers 309 (without optical components), the second bonding layer 409 may be similar to the first bonding layer 315, and the second bond pads 411 may be similar to the first bond pads 319. However, any suitable devices may be utilized.

In an embodiment the first semiconductor device 401 may be configured to work with the photonic integrated circuit 300 for a desired functionality. In some embodiments the first semiconductor device 401 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 401 and the first bonding layer 315 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 409 and the surfaces of the first bonding layer 315. Activating the top surfaces of the first bonding layer 315 and the second bonding layer 409 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 315 and the second bonding layer 409.

After the activation process the first bonding layer 315 and the first semiconductor device 401 may be cleaned using, e.g., a chemical rinse, and then the first semiconductor device 401 is aligned and placed into physical contact with the first bonding layer 315. The first bonding layer 315 and the first semiconductor device 401 are then subjected to thermal treatment and contact pressure to bond the first bonding layer 315 and the first semiconductor device 401. For example, the first bonding layer 315 and the first semiconductor device 401 may be subjected to a pressure of about 200 kPa or less, and a temperature between about 25° C. and about 250° C. to fuse the first bonding layer 315 and the first semiconductor device 401. The first bonding layer 315 and the first semiconductor device 401 may then be subjected to a temperature at or above the eutectic point for material of the first bond pads 319 and the second bond pads 411, e.g., between about 150° C. and about 650° C., to fuse the metal. In this manner, the first bonding layer 315 and the first semiconductor device 401 form a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 4 additionally illustrates that, once the first semiconductor device 401 has been bonded, a first gap-fill material 413 is deposited in order to fill the space around the first semiconductor device 401 and provide additional support. In an embodiment the first gap-fill material 413 may be a material such as silicon oxide, silicon nitride, silicon oxynitride, combinations of these, or the like, deposited to fill and overfill the spaces around the first semiconductor device 401. However, any suitable material and method of deposition may be utilized.

FIG. 4 also illustrates an attachment of a first support substrate 415 to the first semiconductor device 401 and the first gap-fill material 413. In an embodiment the first support substrate 415 may be a support material that is transparent to the wavelength of light that is desired to be used, such as silicon, and may be attached using, e.g., an adhesive (not separately illustrated). However, in other embodiments the first support substrate 415 may be bonded to the first semiconductor device 401 and the first gap-fill material 413 using, e.g., a bonding process. Any suitable method of attaching the first support substrate 415 may be used.

In some embodiments the first support substrate 415 comprises a first coupling lens 417 positioned to facilitate movement of optical signals from, e.g., an optical fiber (not illustrated in FIG. 4). In an embodiment the first coupling lens 417 may be formed by shaping the material of the support substrate (e.g., silicon) using masking and etching processes. However, any suitable process may be utilized.

Additionally, if desired, a first anti-reflective coating (ARC) (not separately illustrated may be formed on the first coupling lens 417. In an embodiment the first ARC may be one or more layers of materials which help to prevent undesired reflections as light is focused through the first coupling lens 417. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

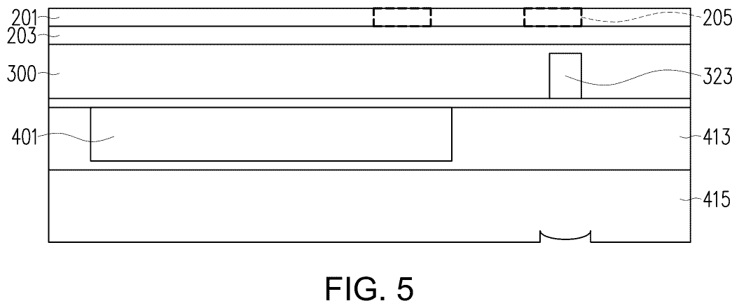

FIG. 5 illustrates a removal of the first substrate 101, the first isolation layer 103, and the second isolation layer 105, thereby exposing the first dielectric layer 201 and portions of the second dielectric layer 203 surrounding the backside optical components 205. In an embodiment the first substrate 101, the first isolation layer 103, and the second isolation layer 105 may be removed using a planarization process, such as a chemical mechanical polishing process, a grinding process, one or more etching processes, combinations of these, or the like. However, any suitable method may be used in order to remove the first substrate 101, the first isolation layer 103, and the second isolation layer 105.

FIGS. 6A-6B illustrate a modulation device 600 that may be bonded to the first dielectric layer 201 in order to provide a modulation material isolated from a remainder of the PIC 300. In an embodiment, the modulation device 600 comprises a modulation substrate 601 along with an overlying modulator 603. In an embodiment the modulation substrate 601 may be similar to the first substrate 101, such as by being a semiconductor material such as silicon or the like.

Looking next at the modulator 603, in some embodiments the modulator 603 is a Mach-Zehnder modulator (MZM), although any suitable modulator may also be utilized. In such an embodiment in which the modulator 603 is a Mach-Zehnder modulator, the modulator 603 may comprise modulating units 605, cladding material 607, and core material 609. Looking first at the modulating units 605, the modulating units 605 may be metal resistive heaters which comprise a metal material such as copper, aluminum, etc., which can be heated through, e.g., resistive heating as a current is run through the modulating units 605. In this embodiment the modulating units 605 may be formed using similar processes and materials as the electrical components of the first metallization layer 309 (e.g., a damascene or dual damascene process). Any suitable structure may be utilized, and all such structures are fully intended to be included within the scope of the embodiments.

The cladding material 607 and the core material 609 may be formed using similar process and materials as the material for the second optical components 307 and the dielectric material of the first metallization layer 309. For example, a first layer of the cladding material 607 (e.g., a dielectric material) may be deposited, the material of the core material 609 (e.g., lithium niobate to form a thin film lithium niobate device) may be deposited and patterned as desired, and then another layer of the cladding material 607 is deposited to cover the patterned core material 609. However, any suitable materials and processes may be utilized.

FIG. 6B illustrates a top down view of one embodiment of the modulator 603 when the modulator 603 is the Zach-Mehnder modulator with the core material 609 (wherein the cladding material 607 in FIG. 6B has been removed for clarity). In the illustrated embodiment the modulator 601 comprises two waveguides 611 formed into a splitter section 613 (wherein the waveguides 611 are close enough to evanescently couple) and a combiner section 615 (wherein the waveguides 611 are, again, close enough to evanescently couple) connected by two waveguides 611 arranged into a first connecting arm 617 and a second connecting arm 619.

In addition to the waveguides 611 being formed as illustrated, the modulator 603 additionally includes the modulating units 605 located adjacent to both of the first connecting arm 617 and the second connecting arm 619. In other embodiments the modulating units 605 may be formed along a single one of the waveguides 611, or else may be formed along both the first connecting arm 617 and the second connecting arm 619. In even further embodiments, one or more modulating units 605 may be formed adjacent to a single one of the waveguides 611. Any suitable configurations may be utilized, and all such configurations are fully intended to be included within the scope of the embodiments.

Returning to FIG. 6A, in order to control the modulating units 605, modulating through substrate vias (TSVs) (also known as through device vias (TDVs) 621 are formed in order to connect the modulating units 605 to off device drivers (not separately illustrated). In an embodiment the modulating through device vias 621 extend through the modulating substrate 601 so as to provide a quick passage of power, data, and ground to the modulating units 605. In an embodiment the modulating through device vias 621 may be formed by initially forming modulating through device via openings into the modulating substrate 601. The modulating through device via openings may be formed by applying and developing a suitable photoresist (not shown), and removing portions of the modulating substrate 601 that are exposed.

Once the modulating through device via openings have been formed, the modulating through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the modulating through device via openings, a barrier layer (also not independently illustrated) may be formed and the remainder of the modulating through device via openings may be filled with conductive material. The conductive material may comprise copper, although other suitable materials such as aluminum, alloys, doped polysilicon, combinations thereof, and the like, may be utilized. The conductive material may be formed by electroplating copper onto a seed layer (not shown), filling and overfilling the modulating through device via openings. Once the modulating through device via openings have been filled, excess liner, barrier layer, seed layer, and conductive material outside of the modulating through device via openings may be removed through a planarization process such as chemical mechanical polishing (CMP), although any suitable removal process may be used.

The modulating device 600 may be sized to provide any suitable number of modulators 603 (with only a single modulator 603 illustrated in FIG. 6A for clarity). In some embodiments the modulating device 600 may have a thickness of between about 2 μm and about 4 μm, and in even more particular embodiments the modulating device 600 have dimensions such as 1.2×3×0.7 mm³ or greater. However, any suitable dimensions may be utilized.

FIG. 6C illustrates another embodiment of the modulating device 600. In this embodiment the waveguides 611 are formed as ridge waveguides. Additionally, the modulating units 605 are formed after the waveguide 611 and, as such, lie on an opposite side of the waveguides 611 from the modulating substrate 601. Any suitable configuration may be utilized, and all such configurations are fully intended to be included within the scope of the embodiments.

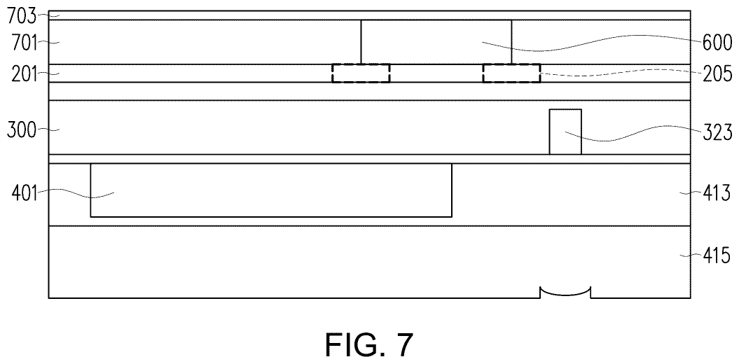

FIG. 7 illustrates that, once the modulating device 600 is formed, the modulating device 600 is bonded to the first dielectric layer 201, using the waveguides within the backside optical components 205 as an optical interposer. In an embodiment the modulating device 600 and the first dielectric layer 201 may be bonded using a dielectric-to-dielectric bonding process. In a particular embodiment which utilizes a dielectric-to-dielectric bonding process, the process may be initiated by activating the surfaces of the modulating device 600 and the first dielectric layer 201. Activating the top surfaces of the modulating device 600 and the first dielectric layer 201 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the modulating device 600 and the first dielectric layer 201.

After the activation process the modulating device 600 and the first dielectric layer 201 may be cleaned using, e.g., a chemical rinse, and then the modulating device 600 is aligned and placed into physical contact with the first dielectric layer 201. The modulating device 600 and the first dielectric layer 201 are then subjected to thermal treatment and contact pressure to bond the modulating device 600 and the first dielectric layer 201. For example, the modulating device 600 and the first dielectric layer 201 may be subjected to a pressure of about 200 kPa or less, and a temperature between about 25° C. and about 250° C. to fuse the modulating device 600 and the first dielectric layer 201. In this manner, the modulating device 600 and the first dielectric layer 201 form a dielectric-to-dielectric bonded device. In some embodiments, the bonded devices are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

Once the modulating device 600 has been bonded, a second gap-fill material 701 is deposited in order to fill the space around the modulating device 600 and provide additional support. In an embodiment the second gap-fill material 701 may be a material such as silicon oxide, silicon nitride, silicon oxynitride, combinations of these, or the like, deposited to fill and overfill the spaces around the modulating device 600. However, any suitable material and method of deposition may be utilized.

After the second gap-fill material 701 has been deposited, a third dielectric layer 703 may be deposited over the modulating device 600 and the second gap-fill material 701. In an embodiment the third dielectric layer 703 may be a dielectric material such as silicon nitride or the like, using a deposition method such as chemical vapor deposition, atomic layer deposition, physical vapor deposition, or the like. The third dielectric layer 703 may be deposited to a thickness of between about 1,000 Å and about 3,000 Å, such as about 2,000 Å. However, any suitable material, process and thickness may be utilized.

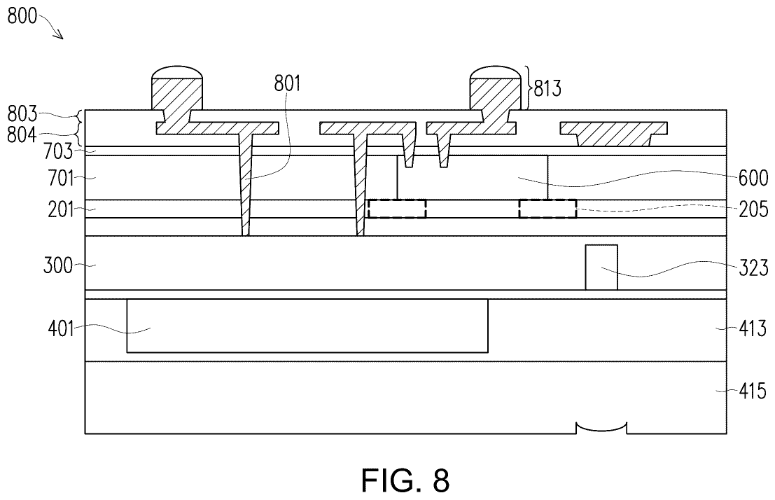

FIG. 8 illustrates formation of first through device vias (TDVs) 801 and formation of a passivation layer 803 to form a first optical package 800 (e.g., a co-packaged optics (CPO)) which, in some embodiments, is an optical engine. In an embodiment the first through device vias 801 extend through the second gap-fill material 701 and, if desired, the first active layer 301 so as to provide a quick passage of power, data, and ground. In an embodiment the first through device vias 801 may be formed by initially forming through device via openings. The through device via openings may be formed by applying and developing a suitable photoresist (not shown), and removing portions of the exposed layer that are exposed.

Once the through device via openings have been formed, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Once the first through device vias 801 have been formed, second metallization layers 804 may be formed in electrical connection with the first through device vias 801. In an embodiment the second metallization layers 804 may be formed as described above with respect to the first metallization layers 309, such as being alternating layers of dielectric and conductive materials using damascene processes, dual damascene process, or the like. In other embodiments, the second metallization layers 804 may be formed using a plating process to form and shape conductive material, and then cover the conductive material with a dielectric material. However, any suitable structures and methods of manufacture may be utilized.

The passivation layer 803 is formed in order to provide protection. In an embodiment the passivation layer 803 may be formed of a dielectric material such as silicon oxide, silicon nitride, polyimide, combinations of these, or the like. The dielectric material may be deposited using any suitable method, such as CVD, high-density plasma chemical vapor deposition (HDPCVD), PVD, atomic layer deposition (ALD), or the like. However, any suitable materials and deposition processes may be utilized.

Additionally, first external connectors 813 may be formed to provide conductive regions for contact to other external devices. The first external connectors 813 may be conductive bumps (e.g., C4 bumps, ball grid arrays, microbumps, etc.), conductive pillars, or a combination thereof, utilizing materials such as solder and copper. In an embodiment in which the first external connectors 813 comprise contact bumps, the first external connectors 813 may comprise a material such as tin, or other suitable materials, such as silver, lead-free tin, or copper. In an embodiment in which the first external connectors 813 are tin solder bumps, the first external connectors 813 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors 813 is one embodiment which may be used in order to provide connections for the first optical package 800, this is intended to be illustrative and is not intended to limit the embodiments. Rather, any suitable method of physically, electrically, and in some cases optically connecting the first optical package 800, such as dielectric-to-dielectric and metal-to-metal bonding, may also be utilized. Any suitable method of bonding the first optical package 800 may be used.

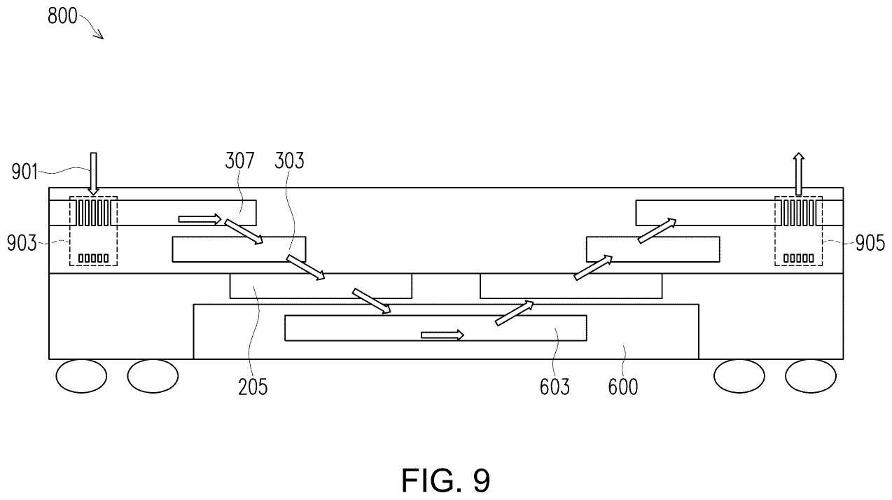

FIG. 9 illustrates a very simplified optical path diagram that illustrates one potential path of optical signals (represented in FIG. 9 by the arrows labeled 901) as the optical signals 901 enter the first optical package 800 and are modulated by the modulation device 600. In the particular embodiment illustrated in FIG. 9, the first active layer 301 of first optical components 303 and the second optical components 307 may be utilized to form a first dual layer grating coupler 903. The optical signals 901 are received by the first dual layer grating coupler 903 and transitioned into a waveguide of the second optical components 307 (e.g., a SiN waveguide 400 nm thick). From the waveguide in the second optical components 307, the optical signals 901 may be transitioned into a waveguide of the first optical components 303 (e.g., a silicon waveguide 270 nm thick) through evanescent coupling. From the waveguide of the first optical components 303, the optical signals 901 may be transitioned to a waveguide within the backside optical components 205 (e.g., a SiN waveguide 400 nm). Finally, the optical signals 901 can be transitioned to a waveguide within the modulating device 600, and the optical signals 901 can be modulated by the modulator 603 (e.g., a Mach-Zehnder modulator with rib waveguides that are 600 nm thick), which is located away from the backside optical components 205 by a distance less than about 200 nm. However, any suitable path may be utilized to receive the optical signals 901, transport the optical signals 901 to the modulator 603, and modulate the optical signals 901.

Once the optical signals 901 have been modulated as desired, the optical signals 901 may be transmitted out of the modulation device 600 and back to a remainder of the first optical package 800. In a particular embodiment the optical signals 901 may be transitioned from the waveguides within the modulation device 600 to a waveguide within the backside optical components 205. From the waveguide within the backside optical components 205, the optical signals 901 may be transitioned into a waveguide of the first optical components 303 (e.g., a silicon waveguide) through evanescent coupling. The optical signals 901 may then be transitioned into a waveguide of the second optical components 307 (e.g., a SiN waveguide). From there, the optical signals 901 may either be routed to other devices of the first optical package 800 or else may be routed out of the first optical package 800 using, e.g., a second dual layer grating coupler 905. However, any suitable routing of the optical signals 901 into and out of the modulation device 600 may be utilized.

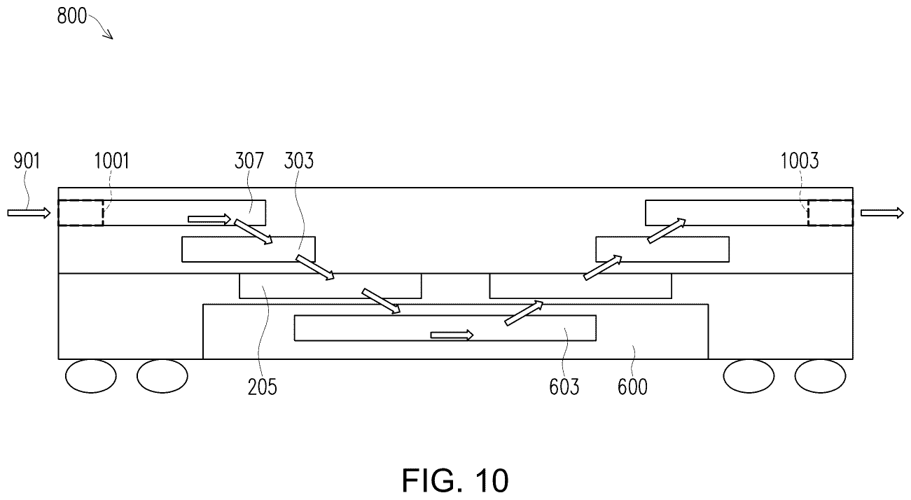

FIG. 10 illustrates another embodiment of the very simplified optical path diagram that illustrates one potential path of optical signals (represented in FIG. 10 by the arrows labeled 901) as the optical signals 901 enter the first optical package 800 and are modulated by the modulation device 600. In the particular embodiment illustrated in FIG. 10, however, instead of the first dual layer grating coupler 903 being used to receive the optical signals 901, an edge coupler 1001 is utilized. The optical signals 901 are received by the edge coupler 1001 and transitioned into a waveguide of the second optical components 307 (e.g., a SiN waveguide). From the waveguide in the second optical components 307, the optical signals 901 may be transitioned into a waveguide of the first optical components 303 (e.g., a silicon waveguide) through evanescent coupling. From the waveguide of the first optical components 303, the optical signals 901 may be transitioned to a waveguide within the backside optical components 205 (e.g., a SiN waveguide). Finally, the optical signals 901 can be transitioned to a waveguide within the modulation device 600, and the optical signals 901 can be modulated by the modulator 603 (e.g., a Mach-Zehnder modulator). However, any suitable path may be utilized to receive the optical signals 901, transport the optical signals 901 to the modulator 603, and modulate the optical signals 901.

Once the optical signals 901 have been modulated as desired, the optical signals 901 may be transmitted out of the modulation device 600 and back to a remainder of the first optical package 800. In a particular embodiment the optical signals 901 may be transitioned from the waveguides within the modulation device 600 to a waveguide within the backside optical components 205. From the waveguide within the backside optical components 205, the optical signals 901 may be transitioned into a waveguide of the first optical components 303 (e.g., a silicon waveguide) through evanescent coupling. The optical signals 901 may then be transitioned into a waveguide of the second optical components 307 (e.g., a SiN waveguide). From there, the optical signals 901 may either be routed to other devices of the first optical package 800 or else may be routed out of the first optical package 800 using, e.g., a second edge coupler 1003. However, any suitable routing of the optical signals 901 into and out of the modulation device 600 may be utilized.

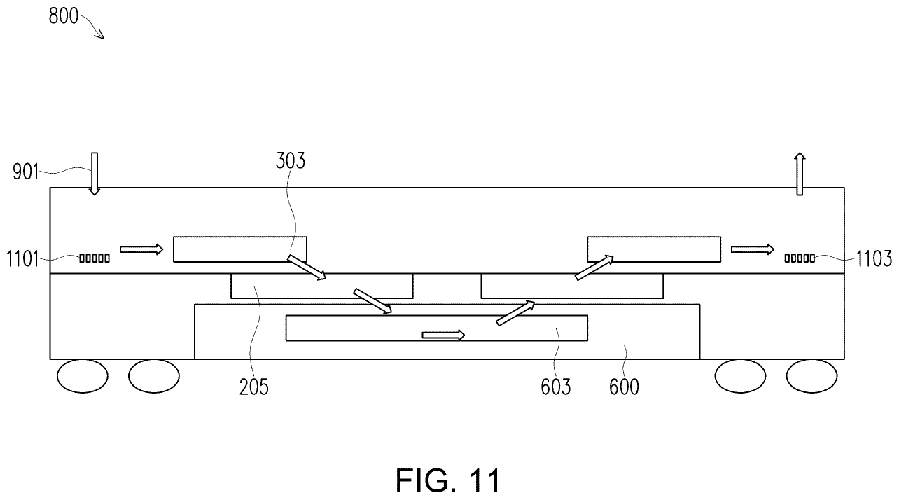

FIG. 11 illustrates yet another embodiment of the very simplified optical path diagram that illustrates one potential path of optical signals (represented in FIG. 11 by the arrows labeled 901) as the optical signals 901 enter the first optical package 800 and are modulated by the modulation device 600. In the particular embodiment illustrated in FIG. 11, however, instead of the first dual layer grating coupler 903 (illustrated in FIG. 9) or the edge coupler 1001 in the first optical components 303 (illustrated in FIG. 10) being used to receive the optical signals 901, a first grating coupler 1101 located within the first active layer 301 of the first optical components 303 is utilized. In this embodiment the optical signals 901 are received by the first grating coupler 1101 and transitioned into a waveguide of the first optical components 303 (e.g., a silicon waveguide). From the waveguide of the first optical components 303, the optical signals 901 may be transitioned to a waveguide within the backside optical components 205 (e.g., a SiN waveguide). Finally, the optical signals 901 can be transitioned to a waveguide within the modulation device 600, and the optical signals 901 can be modulated by the modulator 603 (e.g., a Mach-Zehnder modulator). However, any suitable path may be utilized to receive the optical signals 901, transport the optical signals 901 to the modulator 603, and modulate the optical signals 901.

Once the optical signals 901 have been modulated as desired, the optical signals 901 may be transmitted out of the modulation device 600 and back to a remainder of the first optical package 800. In a particular embodiment the optical signals 901 may be transitioned from the waveguides within the modulation device 600 to a waveguide within the backside optical components 205. From the waveguide within the backside optical components 205, the optical signals 901 may be transitioned into a waveguide of the first optical components 303 (e.g., a silicon waveguide) through evanescent coupling. The optical signals 901 may then be routed to other devices of the first optical package 800 or else may be routed out of the first optical package 800 using, e.g., a second grating coupler 1103 located within the first active layer 301 of first optical components 303. However, any suitable routing of the optical signals 901 into and out of the modulation device 600 may be utilized.

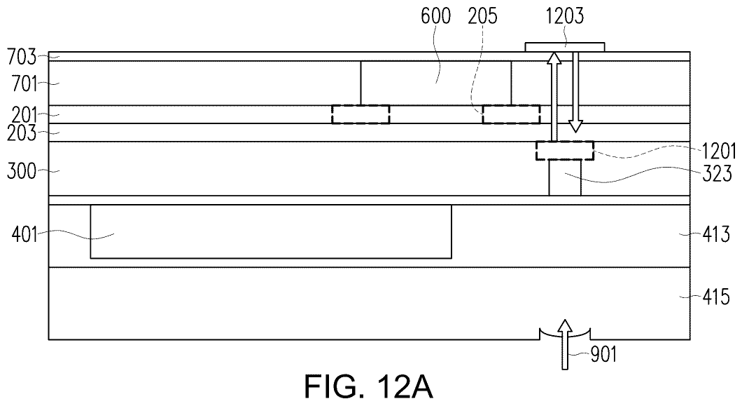

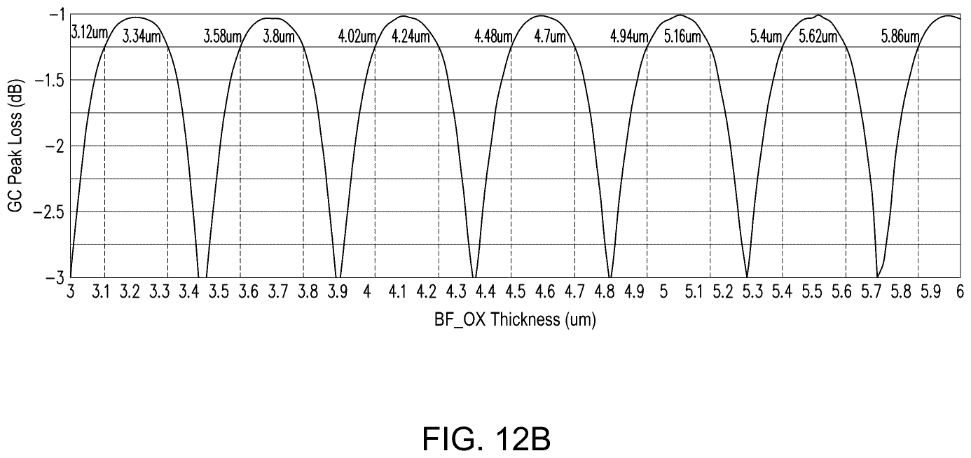

FIG. 12A illustrates yet another embodiment in which a grating coupler 1201 (or dual layer grating coupler or edge coupler) is located within the first active layer 301 and is utilized in order to receive and/or transmit the optical signals 901. In this embodiment, after forming the structure as described above with respect to FIG. 7, one or more reflectors 1203 (e.g., a different reflector for each grating coupler present) are formed and positioned so that portions of the optical signals 901 that are not initially caught by the grating coupler 1201 are reflected back to the grating coupler 1201 in order to increase the overall capture efficiency of the grating coupler 1201. In an embodiment the one or more reflectors 1203 may be formed along the top surface of the third dielectric layer 703. In an embodiment the one or more reflectors 1203 may be a single layer of a reflective material such as aluminum copper, copper, gold, aluminum, titanium nitride, combinations of these, or the like, or else may be a multi-layer structure such as a Braggs reflector comprising alternating layers of different materials, such as alternating layers of silicon dioxide and amorphous silicon. The individual materials of the one or more reflectors 1203 may be deposited using any suitable methods, such as chemical vapor deposition, physical vapor deposition, plating, combinations of these, or the like, and the individual layers may be then be further patterned using, e.g., a photolithographic masking and etching process. However, any suitable materials and methods may be utilized in order to form the first mirror 1011 along the sidewalls of the recess. Further, once the reflectors 1203 have been formed, additional processing may be performed as described above with respect to FIGS. 8-11 in order to complete the first optical package 800.

In the embodiments in which the reflectors 1203 are utilized, the returning light that has been reflected off of the reflectors 1203 will interfere with the optical signals 901 first encountering the grating coupler 1201. As such, the dimensions of the second gap-fill material 701 should be thick enough so that the interference is constructive and increases the light intensity at the grating coupler 1201 to a maximum. In particular embodiments in which the third dielectric layer 703, the first dielectric layer 201, and the second dielectric layer 203 have the dimensions as described above, the second gap-fill material 701 may have a thickness that increases the light intensity at the grating coupler 1201. As such, the thickness may be determined using the chart illustrated in FIG. 12B, such as 3.2 μm, 3.7 μm, etc. However, any suitable dimensions may be utilized.

Additionally, the gap between waveguides within the first dielectric layer 201 and the waveguides within the first active layer 301 of first optical components 303 should be spaced in order to minimize insertion loss. In some embodiments the gap width should be between about 0.2 μm and about 0.3 μm, for an insertion loss of between about −0.37 dB and −0.2 dB. However, any suitable gap spacing may be utilized.

By utilizing the modulating device 600, problematic materials such as lithium niobate, which tend to contaminate and poison surrounding materials, can be utilized in optical modulators. As such, high-speed modulation (e.g., achieving data rates beyond 400 Gb/s) for 100 GHz devices can be obtained, leading to an increase in the data bandwidth, and allowing for a realistic, achievable integration of thin film lithium niobate structures in an optical package without the usual lithium contamination. Further, the embodiments presented have a high compatibility with current manufacturing processes.

In some embodiments, a method of forming an optical device includes: forming a photonic integrated circuit comprising first optical components, the first optical components comprising waveguides connected to a coupler; bonding a first semiconductor device to the photonic integrated circuit; and bonding a modulating device to the photonic integrated circuit, the modulating device comprising a modulator with lithium niobate, wherein after the bonding the modulator is optically coupled to the waveguides. In an embodiment the coupler is a grating coupler. In an embodiment the method further includes, after the bonding the modulating device, forming a reflector positioned to reflect an optical signal back to the grating coupler. In an embodiment the modulator is a Mach-Zehnder modulator. In an embodiment the forming the photonic integrated circuit includes: forming a first active layer of first optical components; and forming a second active layer of second optical components over the first active layer, wherein the coupler is located within the second active layer of second optical components. In an embodiment the coupler is a dual layer grating coupler. In an embodiment the method further includes forming the modulating device.

In another embodiment, a method of forming an optical device includes: bonding a first semiconductor device to a first side of a photonic integrated circuit, the photonic integrated circuit comprising couplers and waveguides; and bonding a modulator device to the photonic integrated circuit on an opposite side from the first semiconductor device, the modulator device comprising a lithium niobate film. In an embodiment the method further includes forming the photonic integrated circuit. In an embodiment the lithium niobate film is part of a Mach-Zehnder modulator. In an embodiment at least one of the couplers is a grating coupler. In an embodiment the method further includes, after the bonding the modulator device, forming a reflector positioned to reflect optical signals to the grating coupler. In an embodiment at least one of the couplers is an edge coupler. In an embodiment the modulator device comprises a through substrate via.

In another embodiment, an optical device includes: a modulator device comprising a lithium niobate film; a first waveguide located over the modulator device, the first waveguide in optical connection with the modulator device; a photonic integrated circuit bonded over the modulator device, the first waveguide being located between the modulator device and the photonic integrated circuit, the photonic integrated circuit including: a second waveguide optically connected to the first waveguide; a coupler optically connected to the second waveguide; and an electronic integrated circuit bonded over the photonic integrated circuit. In an embodiment the coupler is an edge coupler. In an embodiment the coupler is a grating coupler. In an embodiment the optical device further includes a reflector located on an opposite side of the modulator device from the grating coupler and positioned to reflect optical signals to the grating coupler. In an embodiment the grating coupler is a dual layer grating coupler. In an embodiment the grating coupler is located on an opposite side of a first active layer of first optical components from the first waveguide.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an optical device, the method comprising:
forming a photonic integrated circuit comprising first optical components, the first optical components comprising waveguides connected to a coupler;
bonding a first semiconductor device to the photonic integrated circuit; and
bonding a modulating device to the photonic integrated circuit, the modulating device comprising a modulator with lithium niobate, wherein after the bonding the modulator is optically coupled to the waveguides.

2. The method of claim 1, wherein the coupler is a grating coupler.

3. The method of claim 2, further comprising, after the bonding the modulating device, forming a reflector positioned to reflect an optical signal back to the grating coupler.

4. The method of claim 1, wherein the modulator is a Mach-Zehnder modulator.

5. The method of claim 1, wherein the forming the photonic integrated circuit comprises:
forming a first active layer of first optical components; and
forming a second active layer of second optical components over the first active layer, wherein the coupler is located within the second active layer of second optical components.

6. The method of claim 1, wherein the coupler is a dual layer grating coupler.

7. The method of claim 1, further comprising forming the modulating device.

8. A method of forming an optical device, the method comprising:
bonding a first semiconductor device to a first side of a photonic integrated circuit, the photonic integrated circuit comprising couplers and waveguides; and
bonding a modulator device to the photonic integrated circuit on an opposite side from the first semiconductor device, the modulator device comprising a lithium niobate film.

9. The method of claim 8, further comprising forming the photonic integrated circuit.

10. The method of claim 8, wherein the lithium niobate film is part of a Mach-Zehnder modulator.

11. The method of claim 8, wherein at least one of the couplers is a grating coupler.

12. The method of claim 11, further comprising, after the bonding the modulator device, forming a reflector positioned to reflect optical signals to the grating coupler.

13. The method of claim 8, wherein at least one of the couplers is an edge coupler.

14. The method of claim 8, wherein the modulator device comprises a through substrate via.

15. An optical device comprising:
a modulator device comprising a lithium niobate film;
a first waveguide located over the modulator device, the first waveguide in optical connection with the modulator device;
a photonic integrated circuit bonded over the modulator device, the first waveguide being located between the modulator device and the photonic integrated circuit, the photonic integrated circuit comprising:
a second waveguide optically connected to the first waveguide;
a coupler optically connected to the second waveguide; and
an electronic integrated circuit bonded over the photonic integrated circuit.

16. The optical device of claim 15, wherein the coupler is an edge coupler.

17. The optical device of claim 15, wherein the coupler is a grating coupler.

18. The optical device of claim 17, further comprising a reflector located on an opposite side of the modulator device from the grating coupler and positioned to reflect optical signals to the grating coupler.

19. The optical device of claim 17, wherein the grating coupler is a dual layer grating coupler.

20. The optical device of claim 17, wherein the grating coupler is located on an opposite side of a first active layer of first optical components from the first waveguide.
